(19) United States
(12) Patent Application Publication
(10) Pub. No.: US 2007/0085764 A1
(43) Pub. Date: Apr. 19, 2007

(54) Plasma display apparatus

(75) Inventors: Jongwoon Bae, Gumi-si (KR); Kirack Park, Chilgok-gun (KR); Seonghwan Ryu, Gumi-si (KR); Yoonjoo Cho, Seoul (KR); Dooyong Hwang, Yongin-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/580,043

(22) Filed: Oct. 13, 2006

(30) Foreign Application Priority Data
Oct. 14, 2005 (KR) 10-2005-0097232

(51) Int. Cl. G09G 3/28

(52) U.S. Cl. 345/60

(57) ABSTRACT

A plasma display apparatus is disclosed. The plasma display apparatus includes a plurality of scan electrodes, a plurality of sustain electrodes, a plurality of data electrodes, a scan driver, and a data driver. The scan driver supplies scan signals to the plurality of scan electrodes using one scan type selected from a plurality of scan types, each scan type having a different order of supplying the scan signals, during an address period. The data driver supplies a data signal to the plurality of data electrodes in response to the selected scan type. The width of the data electrode at a first location is different from the width of the data electrode at a second location.

This Nonprovisional application claims priority under 35 U.S.C. § 119(a) on Patent Application Ser. No. 10-2005-0097232 filed in Korea on Oct. 14, 2006 the entire contents of which are hereby incorporated by reference.

### BACKGROUND

1. Field

This document relates to a display apparatus, and more particularly, to a plasma display apparatus.

2. Description of the Related Art

A plasma display panel comprises a front panel, a rear panel and barrier ribs formed between the front panel and the rear panel. The barrier ribs forms unit discharge cell or discharge cells. The plurality of discharge cells form one pixel. For example, a red (R) discharge cell, a green (G) discharge cell, and a blue (B) discharge cell form one pixel.

Each of discharge cells is filled with an inert gas containing a main discharge gas such as neon (Ne), helium (He) and a mixture of Ne and He, and a small amount of xenon (Xe). When it is discharged by a high frequency voltage, the inert gas generates vacuum ultra-violet rays, which thereby cause a phosphor formed inside the discharge cell to emit light, thus displaying an image. Since the plasma display panel can be manufactured to be thin and light, it has attracted attention as a next generation display device.

A plurality of electrodes, for example, a scan electrode, a sustain electrode and a data electrode are formed in the plasma display panel. A driver supplies a predetermined driving voltage to the plurality of electrodes to generate a discharge such that an image is displayed. The driver for supplying the predetermined driving voltage to the plurality of electrodes of the plasma display panel is connected to the plurality of electrodes in the form of a driver integrated circuit (IC).

For example, a data driver IC is connected to the data electrode of the plasma display panel, and a scan driver IC is connected to the scan electrode of the plasma display panel.

When driving the plasma display panel, the displacement current flows in these driver ICs. A magnitude of the displacement current varies by various factors.

For example, a displacement current flowing in the data driver IC may increase or decrease depending on equivalence capacitance of the plasma display panel and the number of switching operations of the data driver IC.

In particular, when image data is a specific pattern where logical values 1 and 0 are repeatedly input, the displacement current flowing in the data driver IC excessively increases such that the data driver IC is electrically damaged.

### SUMMARY

In one aspect, a plasma display apparatus comprises a plurality of scan electrodes, a plurality of sustain electrodes formed in parallel to the plurality of scan electrodes, a plurality of data electrodes formed to intersect the plurality of scan electrodes and the plurality of sustain electrodes, a scan driver for supplying scan signals to the plurality of scan electrodes using one scan type selected from a plurality of scan types, each scan type having a different order of supplying the scan signals, during an address period, and a data driver for supplying a data signal to the plurality of data electrodes in response to the selected scan type, wherein the width of the data electrode at a first location is different from the width of the data electrode at a second location.

In another aspect, a plasma display apparatus comprises a plurality of scan electrodes each comprising a bus electrode, a plurality of sustain electrodes, each comprising a bus electrode, formed in parallel to the plurality of scan electrodes, a plurality of data electrodes formed to intersect the plurality of scan electrodes and the plurality of sustain electrodes, a scan driver for supplying scan signals to the plurality of scan electrodes using a first scan type in a first subfield of a frame, and for supplying the scan signals to the plurality of scan electrodes using a second scan type, which directs the scan driver to supply the scan signals in an order different from the first scan type, in a second subfield of the frame, and a data driver for supplying a data signal corresponding to the scan signals to the plurality of data electrodes during an address period, wherein the width of the data electrode at a location corresponding to the inside of a discharge cell becomes narrower near a boundary of the discharge cell, and is then constant, and the bus electrode is formed at a location corresponding to the inside of the discharge cell.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 illustrates the configuration of a plasma display apparatus according to one embodiment;

FIG. 2 illustrates an example of the structure of a plasma display panel of the plasma display apparatus according to the embodiment;

FIG. 3 illustrates the electrode structure of the plasma display apparatus according to the embodiment;

FIGS. 4a and 4b are views for comparing characteristics of address discharges of a related art plasma display panel and a plasma display panel according to the embodiment;

FIGS. 5a to 5d illustrate various electrode structures of the plasma display apparatus according to the embodiment;

FIG. 6 illustrates the size of a discharge cell in the electrode structure of the plasma display apparatus according to the embodiment;

FIG. 7 illustrates an example of the method of driving the plasma display apparatus;

FIG. 8 illustrates an example of a driving waveform in accordance with the method of driving the plasma display apparatus;

FIGS. 9a and 9b illustrate various scan types which are different from one another in the order of supplying scan signals to a plurality of scan electrodes;

FIG. 10 illustrates a plurality of scan types, which are different from one other in the order of supplying scan signals to the plurality of scan electrodes.

FIG. 11 illustrates one example of a method for determining a scan type by block;

FIG. 12 illustrates another example of a method for determining a scan type relative to a threshold value of the number of switching operations of the data driver;

FIG. 13 illustrates another example of a method for supplying scan signals to the plurality of scan electrodes using a plurality of scan types which are different from one other in the order of supplying the scan signals to the scan electrodes; and

FIG. 14 illustrates one example of a method for determining a scan type in consideration of a subfield.

### DETAILED DESCRIPTION OF PREFERRED EMBODIMENTS

Preferred embodiments of the present invention will be described in a more detailed manner with reference to the drawings.

A plasma display apparatus comprises a plurality of scan electrodes, a plurality of sustain electrodes formed in parallel to the plurality of scan electrodes, a plurality of data electrodes formed to intersect the plurality of scan electrodes and the plurality of sustain electrodes, a scan driver for supplying scan signals to the plurality of scan electrodes using one scan type selected from a plurality of scan types, each scan type having a different order of supplying the scan signals, during an address period, and a data driver for supplying a data signal to the plurality of data electrodes in response to the selected scan type, wherein the width of the data electrode at a first location is different from the width of the data electrode at a second location.

The scan driver may supply the scan signals to the plurality of scan electrodes using one scan type selected from the plurality of scan types, wherein the number of switching operations of the data driver with respect to the selected scan type is less than the number of switching operations of the data driver with respect to each of the non-selected scan types in response to input image data.

The number of switching operations of the data driver may equal the number of changes in a voltage level of the data signal.

At least one of the plurality of scan types may comprise a scan type for consecutively supplying the scan signals to the odd-numbered scan electrodes and then to the even-numbered scan electrodes, or for consecutively supplying the scan signals to the even-numbered scan electrodes and then to the odd-numbered scan electrodes.

The plurality of scan electrodes may comprise a first scan electrode, a second scan electrode, and a third scan electrode, adjacent to one another, to which the scan signals are supplied in a consecutive order. A distance between the first scan electrode and the second scan electrode may be substantially equal to a distance between the second scan electrode and the third scan electrode.

The scan driver may supply the scan signals to the plurality of scan electrodes using one scan type selected from the plurality of scan types, wherein the number of switching operations of the data driver with respect to the selected scan type is less than the number of switching operations of the data driver with respect to each of the non-selected scan types in response to image data input for each subfield of a frame.

At least one of the plurality of scan types may comprise a scan type for consecutively supplying the scan signals to the scan electrodes of one scan electrode group.

The scan driver may supply the scan signals to the plurality of scan electrodes using at least one of the plurality of scan types, in which the number of switching operations of the data driver in response to input image data is equal to or less than a threshold value.

The plurality of scan types may comprise a first scan type for consecutively supplying the scan signals to the plurality of scan electrodes. The scan driver may supply the scan signals to the scan electrodes using the first scan type when the number of switching operations of the data driver with respect to the first scan type in response to input image data is equal to or less than a threshold value. The scan driver may supply the scan signals to the scan electrodes using a second scan type, which supplies the scan signals in an order different from the first scan type, when the number of switching operations of the data driver with respect to the first scan type in response to input image data is equal to or more than the threshold value.

The first location may be a location corresponding to the inside of a discharge cell, and the second location may be a location corresponding to a barrier rib.

The width of the data electrode at the first location may be more than the width of the data electrode at the second location.

The width of the data electrode at the first location may range from 1.05 to 1.6 times the width of the data electrode at the second location.

The width of the data electrode at the second location may range from 1.05 to 2 times the width of a transverse barrier rib.

The size of at least one discharge cell of a plurality of discharge cells coated with a plurality of colors may be different from the size of the remaining discharge cells.

The scan electrode and the sustain electrode each may comprise a bus electrode, and the bus electrode may be formed at a location corresponding to the inside of the discharge cell.

The first location may be a location corresponding to the scan electrode, and the second location may be a location corresponding to the sustain electrode.

The width of the data electrode at the first location may be more than the width of the data electrode at the second location.

A plasma display apparatus comprises a plurality of scan electrodes each comprising a bus electrode, a plurality of sustain electrodes, each comprising a bus electrode, formed in parallel to the plurality of scan electrodes, a plurality of data electrodes formed to intersect the plurality of scan electrodes and the plurality of sustain electrodes, a scan driver for supplying scan signals to the plurality of scan electrodes using a first scan type in a first subfield of a frame, and for supplying the scan signals to the plurality of scan electrodes using a second scan type, which directs the scan driver to supply the scan signals in an order different from the first scan type, in a second subfield of the frame, and a data driver for supplying a data signal corresponding to the scan signals to the plurality of data electrodes during an address period, wherein the width of the data electrode at a location corresponding to the inside of a discharge cell becomes narrower near a boundary of the discharge cell, and is then constant, and the bus electrode is formed at a location corresponding to the inside of the discharge cell.

The number of times of switching of the data driver with respect to the first scan type in the first subfield may be less than the number of times of switching of the data driver with respect to the second type in the first subfield.

The scan driver may supply the scan signals to the plurality of scan electrodes using one scan type of the first scan type and the second scan type, in which the number of switching operations of the data driver in response to input image data is equal to or less than a threshold value.

Hereinafter, exemplary embodiments of the present invention will be described in detail with reference to the attached drawings.

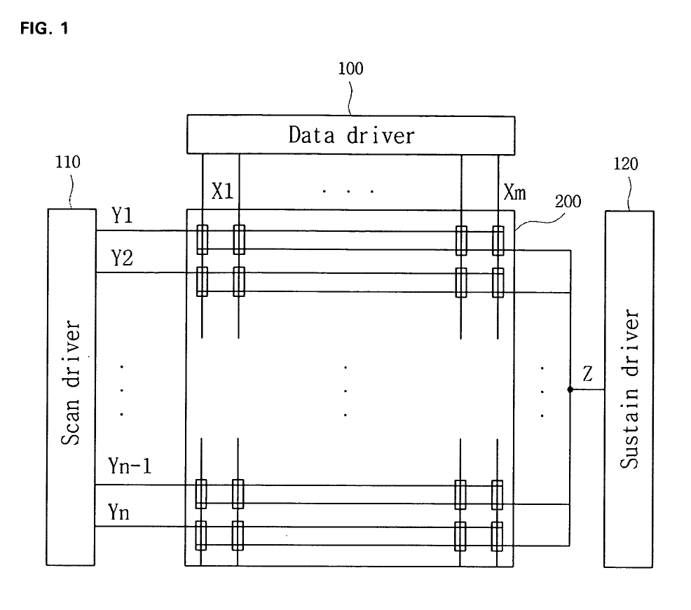

FIG. 1 illustrates the configuration of a plasma display apparatus according to one embodiment.

As illustrated in FIG. 1, the plasma display apparatus according to one embodiment comprises a plasma display panel 200, a data driver 100, a scan driver 110, and a sustain driver 120.

Although FIG. 1 illustrates the data driver 100, the scan driver 110 and the sustain driver 120 as being formed in different board shapes, respectively, at least two of the data driver 100, the scan driver 110, and the sustain driver 120 may be integrated in one board.

The plasma display panel 200 comprises a front panel (not illustrated) and a rear panel (not illustrated) which are coalesced with each other at a given distance. Further, the plasma display panel 200 comprises a plurality of electrodes, for example, scan electrodes Y1 to Yn, sustain electrodes Z formed in parallel to the scan electrodes Y1 to Yn, and data electrodes X1 to Xm formed to intersect the scan electrodes Y1 to Yn and the sustain electrodes Z.

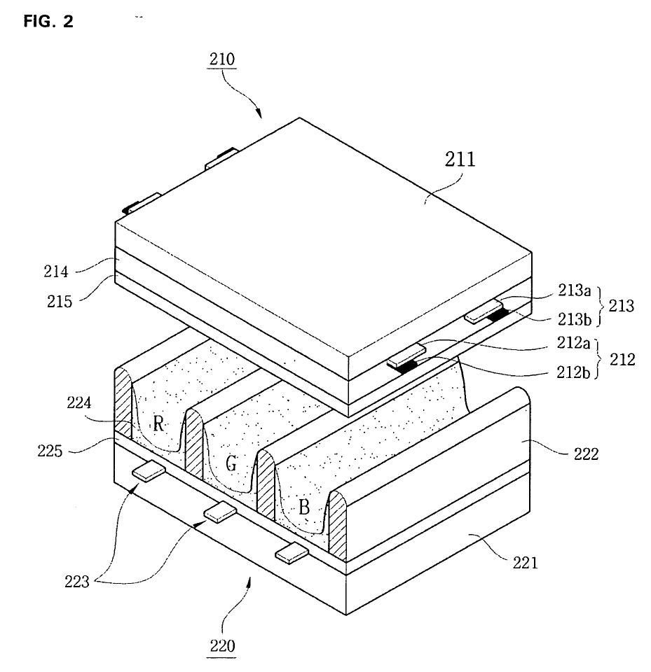

The following is a detailed description of the plasma display panel 200, with reference to FIG. 2.

FIG. 2 illustrates an example of the structure of a plasma display panel of the plasma display apparatus according to the embodiment.

As illustrated in FIG. 2, the plasma display panel comprises a front panel 210 and a rear panel 220 which are coupled in parallel to oppose to each other at a given distance therebetween. The front panel 210 comprises a front substrate 211 which is a display surface. The rear panel 220 comprises a rear substrate 221 constituting a rear surface. A plurality of scan electrodes 212 and a plurality of sustain electrodes 213 are formed in pairs on the front substrate 211, on which an image is displayed, to form a plurality of maintenance electrode pairs. A plurality of data electrodes 223 are arranged on the rear substrate 221 to intersect with the plurality of maintenance electrode pairs.

The scan electrode 212 and the sustain electrode 213 each comprise transparent electrodes 212a and 213a made of transparent indium-tin-oxide (ITO) material and bus electrodes 212b and 213b made of a metal material. The scan electrode 212 and the sustain electrode 213 generate a mutual discharge therebetween in one discharge cell and maintain light emissions of discharge cells. The scan electrode 212 and the sustain electrode 213 each may comprise the transparent electrodes 212a and 213a. Further, the scan electrode 212 and the sustain electrode 213 each may comprise the bus electrodes 212b and 213b. The scan electrode 212 and the sustain electrode 213 are covered with one or more upper dielectric layers 214 to limit a discharge current and to provide insulation between the maintenance electrode pairs. A protective layer 215 with a deposit of MgO is formed on an upper surface of the upper dielectric layer 214 to facilitate discharge conditions.

A plurality of stripe-type (or well-type) barrier ribs 222 are formed in parallel on the rear substrate 221 of the rear panel 220 to form a plurality of discharge spaces (i.e., a plurality of discharge cells). The plurality of data electrodes 223 for performing an address discharge to generate vacuum ultraviolet rays are arranged in parallel to the barrier ribs 222. An upper surface of the rear substrate 221 is coated with Red (R), green (G) and blue (B) phosphors 224 for emitting visible light for an image display when an address discharge is performed. A lower dielectric layer 225 is formed between the data electrodes 223 and the phosphors 224 to protect the data electrodes 223.

The front panel 210 and the rear panel 220 are coalesced by a sealing process such that the plasma display panel is formed. A driving circuit substrate (not illustrated), on which drivers for supplying driving voltages to the scan electrode 212, the sustain electrode 213 and the data electrode 223 are formed, are disposed on a rear surface of the plasma display panel.

Referring again to FIG. 1, the scan driver 110 may supply a rising signal and a falling signal to the scan electrodes Y1 to Yn during a reset period. The scan driver 110 may supply a sustain signal to the scan electrodes Y1 to Yn during a sustain period.

The scan driver 110 may supply scan signals to the scan electrodes Y1 to Yn during an address period using at least one scan type of a plurality of scan types which are different from one another in the order of supplying the scan signals to the plurality of scan electrodes. More specifically, the scan driver 110 supplies the scan signals to the scan electrodes Y1 to Yn using a first scan type in a first subfield of a frame, and supplies the scan signals to the scan electrodes Y1 to Yn using a second scan type, in which is different from the first scan type in the order of supplying the scan signals to the plurality of scan electrodes, in a second subfield of the frame.

The sustain driver 120 supplies a sustain signal to the sustain electrodes Z during the sustain period. The sustain driver 120 and the scan driver 110 alternately operate. Further, the sustain driver 120 supplies a bias signal of a positive polarity to the sustain electrodes Z during the address period.

The data driver 100, under the control of a timing controller (not illustrated), supplies a data signal to the data electrodes X1 to Xm. The data signal supplied to the data driver 100 corresponds to the scan signal supplied by the scan driver 110.

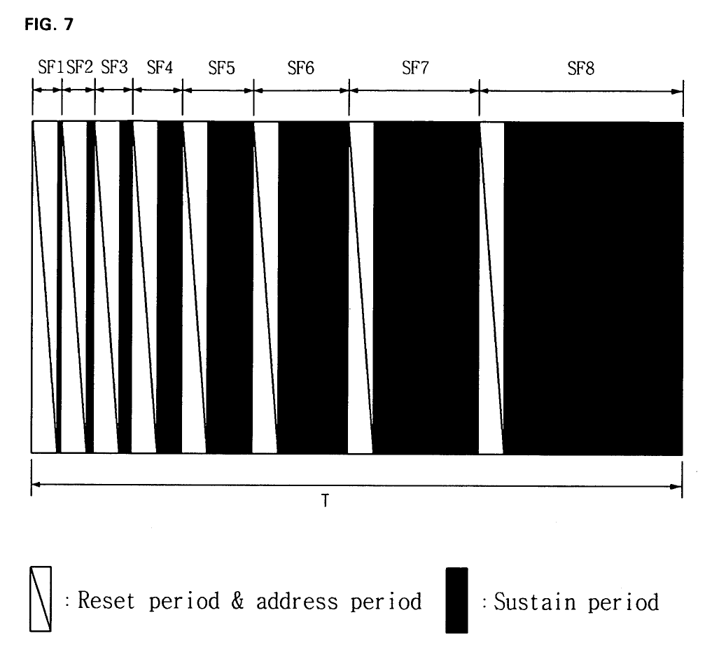

A function and an operation of the plasma display apparatus according to the embodiment will be described later with reference to FIG. 7 and the attached drawings subsequent to FIG. 7.

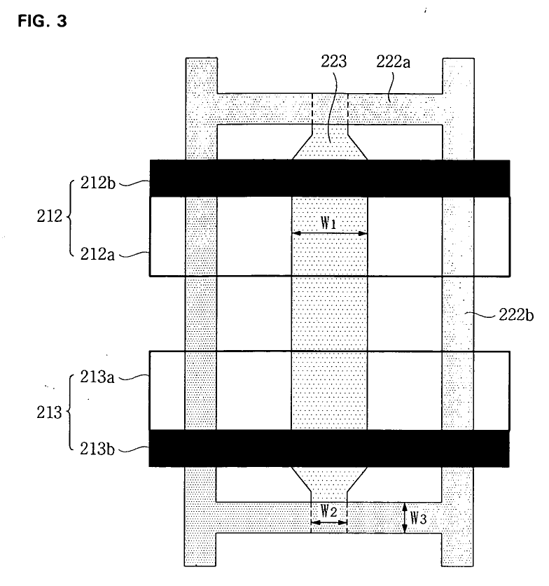

FIG. 3 illustrates the electrode structure of the plasma display apparatus according to the embodiment.

As illustrated in FIG. 3, the plasma display apparatus comprises the scan electrode 212 and the sustain electrode 213 for generating the mutual discharge therebetween in one discharge cell on the plasma display panel and maintaining light emissions of discharge cells. The scan electrode 212 and the sustain electrode 213 each comprise the transparent electrodes 212a and 213a made of a transparent material and the bus electrodes 212b and 213b made of a metal material. The bus electrodes 212b and 213b are formed inside the discharge cell, thereby easily generating a discharge.

One discharge cell is formed at a position where the scan electrode 212 and the sustain electrode 213 intersect the data electrode 223. The discharge cell is partitioned by a transverse barrier rib 222a and a longitudinal barrier rib 222b.

The width of the data electrode 223 may be changed depending on its location. For example, the width of the data electrode 223 at a first location corresponding to the inside of the discharge cell may be different from the width of the data electrode 223 at a second location corresponding to the barrier rib, i.e., the transverse barrier rib 222a. When a width W1 of the data electrode 223 at the first location corresponding to the inside of the discharge cell is more than a width W2 of the data electrode 223 at the second location corresponding to the transverse barrier rib 222a, a discharge characteristic is improved. In other words, the overlap area of the scan electrode 212 and the data electrode 223 or the overlap area of the sustain electrode 213 and the data electrode 223 increase, thereby generating accurately an opposite discharge.

The width W1 of the data electrode 223 at the first location corresponding to the inside of the discharge cell may range from 1.05 to 1.6 times the width W2 of the data electrode 223 at the second location corresponding to the transverse barrier rib 222a. Further, the width W2 of the data electrode 223 at the second location corresponding to the transverse barrier rib 222a may range from 1.05 to 2 times a width W3 of the transverse barrier rib 222a.

When the width W1 of the data electrode 223 at the first location corresponding to the inside of the discharge cell is more than the width W2 of the data electrode 223 at the second location corresponding to the transverse barrier rib 222a, the width W1 of the data electrode 223 at the first location becomes narrower near a boundary of the discharge cell and is then constant to the width W2 at the second location.

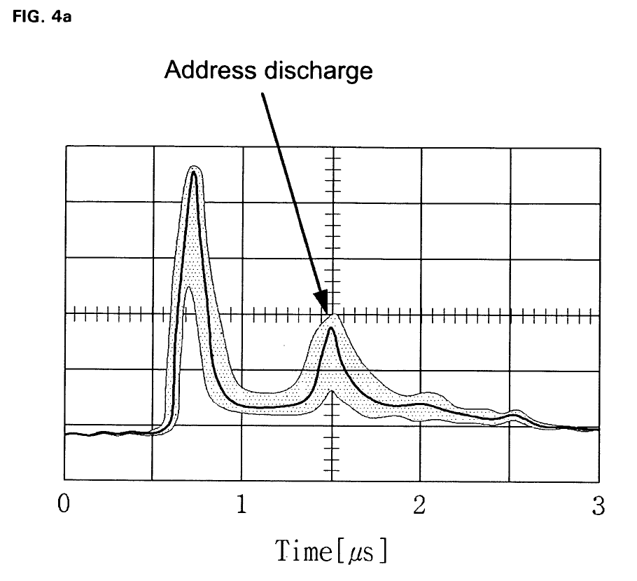

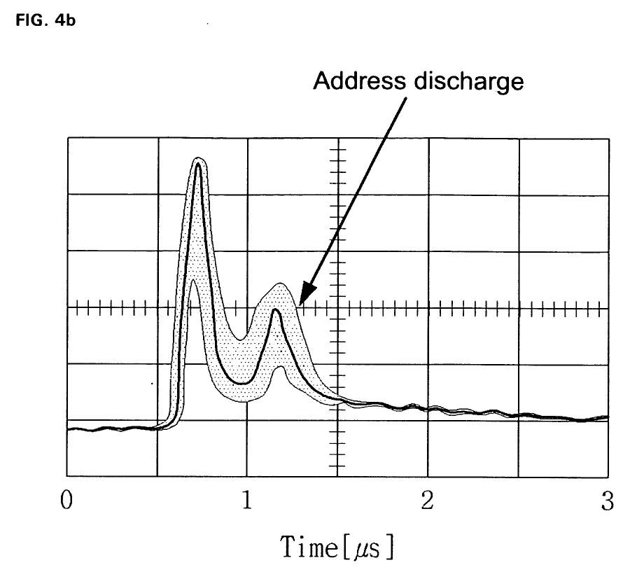

As above, the overlap area of the scan electrode 212 and the data electrode 223 or the overlap area of the sustain electrode 213 and the data electrode 223 increase, thereby generating easily the opposite discharge. As an example of the opposite discharge, an address discharge generated during the address period will be described with reference to FIG. 4.

FIGS. 4a and 4b are views for comparing characteristics of address discharges of a related art plasma display panel and a plasma display panel according to the embodiment.

FIG. 4a illustrates a waveform of discharge light generated when generating an address discharge in the electrode structure of a related art plasma display panel.

FIG. 4b illustrates a waveform of discharge light generated when generating an address discharge in the electrode structure of a plasma display panel according to the embodiment.

In FIG. 4a, when an address discharge being an opposite discharge between a data electrode and a scan electrode occurs in the related art plasma display panel, there is an interval between a start time point of the supplying of a driving signal for generating the address discharge to the data electrode and the scan electrode and a generation time point of the address discharge. In the related art plasma display panel, the interval between the start time point of the supplying of the driving signal and the generation time point of the address discharge is long such that a jitter characteristic is degraded.

On the other hand, in FIG. 4b, the width of the data electrode 223 increases in the electrode structure of the plasma display panel according to the embodiment such that an address discharge being an opposite discharge between the data electrode 223 and the scan electrode 212 occurs easily. Therefore, an interval between a start time point of the supplying of a driving signal for generating the address discharge to the data electrode 223 and the scan electrode 212 and a generation time point of the address discharge is shorter than the interval in the related art plasma display panel. In other words, unlike FIG. 4a, it can be seen from FIG. 4b that the address discharge rapidly occurs without the discharge delay in the plasma display panel according to the embodiment. Accordingly, a jitter characteristic of the plasma display apparatus according to the embodiment is improved, thereby increasing the driving efficiency of the plasma display panel according to the embodiment.

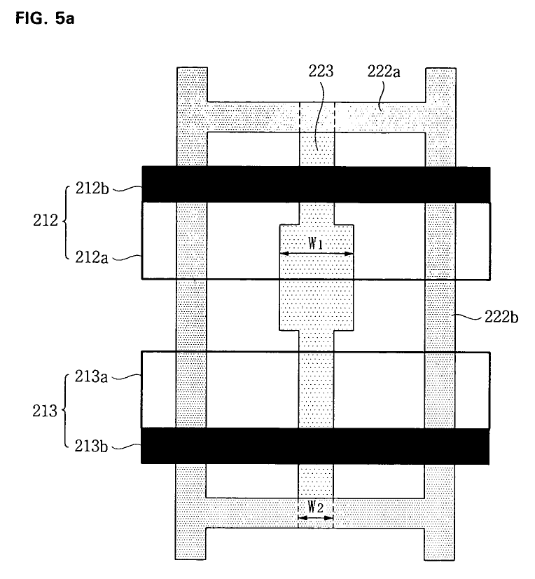

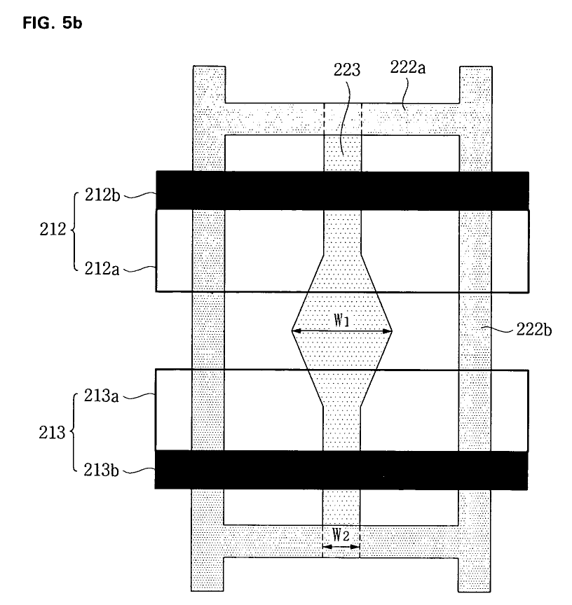

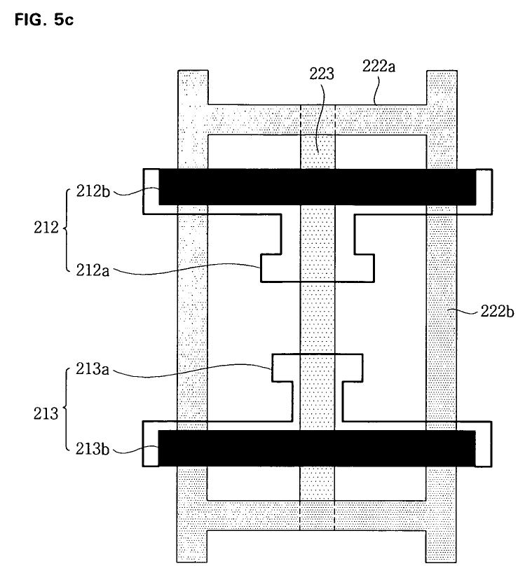

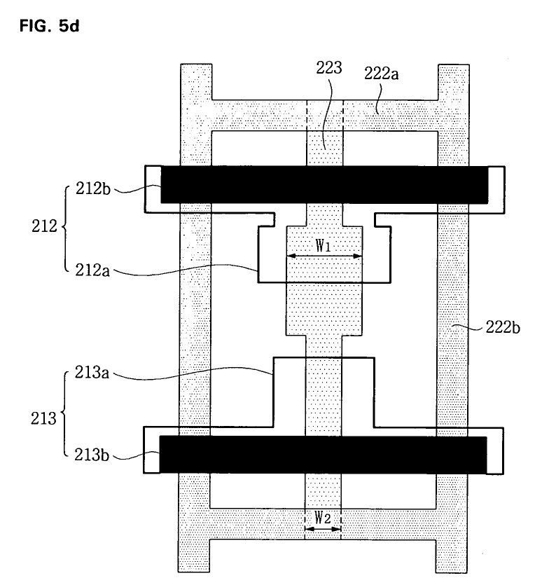

The following is a detailed description of another method for improving a discharge characteristic by controlling the width of the data electrode, with reference to FIGS. 5a to 5d.

FIGS. 5a to 5d illustrate various electrode structures of the plasma display apparatus according to the embodiment.

As illustrated in FIG. 5a, one discharge cell is formed at a position where the scan electrode 212 and the sustain electrode 213 intersect the data electrode 223. The discharge cell is partitioned by the transverse barrier rib 222a and the longitudinal barrier rib 222b.

The width of the data electrode 223 may be changed depending on its location. For example, the width of the data electrode 223 at a first location corresponding to the scan electrode 212 may be different from the width of the data electrode 223 at a second location corresponding to the sustain electrode 213. When a width W1 of the data electrode 223 at the first location corresponding to the scan electrode 212 is more than a width W2 of the data electrode 223 at the second location corresponding to the sustain electrode 213, a discharge characteristic is improved.

As illustrated in FIG. 5b, a width W1 of the data electrode 223 at a first location corresponding to the inside of the discharge cell is more than a width W2 of the data electrode 223 at a second location corresponding to the barrier rib, i.e., the transverse barrier rib 222a. In other words, the width of the data electrode 223 gradually widens toward a central direction of the discharge cell such that a discharge characteristic is improved. The shape of the data electrode 223 may be a diamond.

As illustrated in FIG. 5c, the area of the scan electrode may be controlled such that the overlap area of the scan electrode 212 and the data electrode 223 may be more than the overlap area of the sustain electrode 213 and the data electrode 223. In other words, the overlap area of the scan electrode 212 and the data electrode 223 is more than the overlap area of the sustain electrode 213 and the data electrode 223 by forming the scan electrode 212 larger than the sustain electrode 213, thereby easily generating the address discharge.

As illustrated in FIG. 5d, a width W1 of the data electrode 223 at a first location corresponding to the scan electrode 212 is more than a width W2 of the data electrode 223 at a second location corresponding to the sustain electrode 213, and also the overlap area of the scan electrode 212 and the data electrode 223 is more than the overlap area of the sustain electrode 213 and the data electrode 223 by forming the scan electrode 212 larger than the sustain electrode 213. As a result, the address discharge occurs more easily.

The following is a detailed description of the plurality of discharge cells in the electrode structure according to the embodiment.

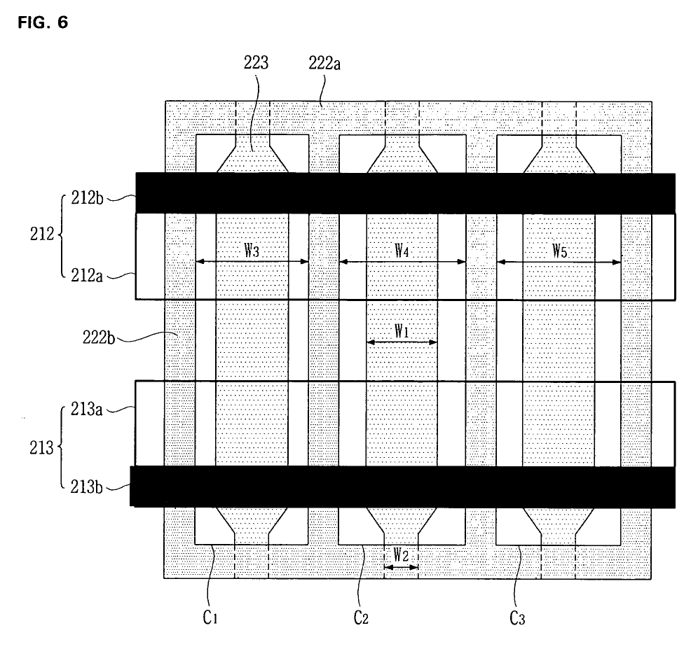

FIG. 6 illustrates the size of a discharge cell in the electrode structure of the plasma display apparatus according to the embodiment.

As illustrated in FIG. 6, the scan electrode 212 and the sustain electrode 213 for generating a mutual discharge therebetween in each of the plurality of discharge cells and maintaining light emissions of the plurality of discharge cells are formed in the plasma display panel. In other words, the scan electrode 212 and the sustain electrode 213 each comprise the transparent electrodes 212a and 213a made of a transparent material and the bus electrodes 212b and 213b made of a metal material. The bus electrodes 212b and 213b are formed inside the discharge cells, thereby more easily generating the discharge.

Each of the plurality of discharge cells is formed at a positions where the scan electrodes 212 and the sustain electrodes 213 intersect the data electrodes 223. Each of the plurality of discharge cells is partitioned by the transverse barrier rib 222a and the longitudinal barrier rib 222b. Three discharge cells Cl, C2 and C3 are illustrated in FIG. 6. The three discharge cells Cl, C2 and C3 are coated with different colors of phosphors such that an image is displayed due to the combination of the different colors.

The width of the data electrode 223 may be changed depending on its location. For example, a width W1 of the data electrode 223 at a first location corresponding to the inside of the discharge cell is more than a width W2 of the data electrode 223 at a second location corresponding to the barrier rib, i.e., the transverse barrier rib 222a such that a discharge characteristic is improved and the image quality is improved. Furthermore, the size of at least one discharge cell of the plurality of discharge cells may be different from the size of the remaining discharge cells such that white balance of the image is optimized. For example, the widths of the three discharge cells C1, C2 and C3 are set to be different from one another, i.e., W3, W4, and W5 such that white balance of the image is optimized depending on light-emission characteristics of the phosphors.

FIG. 7 illustrates an example of a method of driving the plasma display apparatus.

As illustrated in FIG. 7, a frame in the plasma display apparatus is divided into several subfields having a different number of emission times. Each of the subfields is subdivided into a reset period for initializing all the cells, an address period for selecting cells to be discharged, and a sustain period for representing gray level in accordance with the number of discharges.

For example, if an image with 256-level gray level is to be displayed, a frame period is divided into eight subfields SF1 to SF8. Each of the eight subfields SF1 to SF8 is subdivided into a reset period, an address period and a sustain period.

The sustain period determines gray level weight in each of the subfields. For example, gray level weight of a first subfield is set to 2⁰, and gray level weight of a second subfield is set to 2¹. In other words, the sustain period increases in a ratio of 2ⁿ (where, n=0, 1, 2, 3, 4, 5, 6, 7) in each of the subfields. Since the sustain period varies from one subfield to the next subfield, a specific gray level is achieved by controlling the sustain period which are to be used for discharging each of the selected cells, i.e., the number of sustain discharges that are realized in each of the discharge cells.

The plasma display apparatus of the present invention uses a plurality of frames so as to display an image during 1 second. For example, 60 frames are used to display an image during 1 second. In such a case, the length of a frame is equal to 1/60 sec (i.e., 16.67 ms).

The explanation was given of an example of one frame comprising 8 subfields in FIG. 7. However, the number of subfields included in one frame may be variously changed. For example, one frame may comprise 12 subfields SF1 to SF12. Further, one frame may comprise 10 subfields SF1 to SF10.

Moreover, the subfields of one frame are arranged in increasing order of gray level weight in FIG. 7. However, the subfields may be arranged in decreasing order of gray level weight. Further, the subfields may be arranged irrespective of gray level weight.

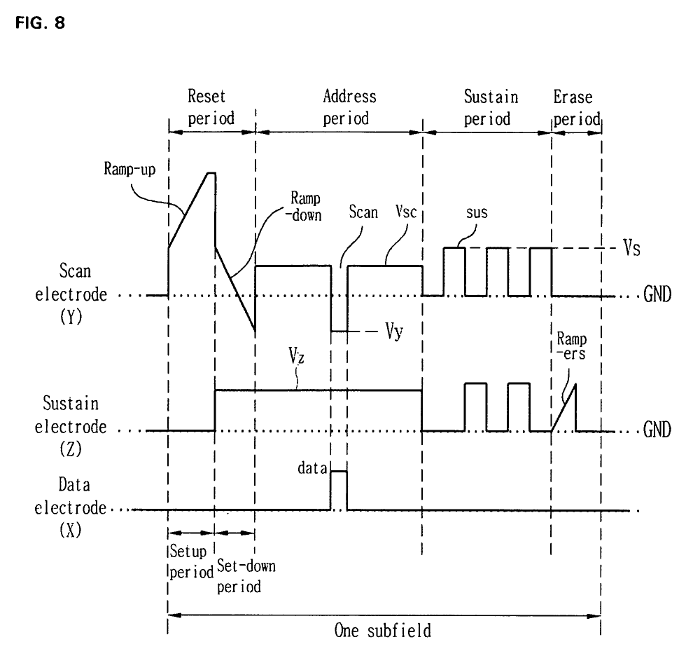

FIG. 8 illustrates an example of a driving waveform in accordance with the method of driving the plasma display apparatus.

In FIG. 8, a driving waveform generated in one subfield of the plurality of subfields constituting one frame is illustrated.

One subfield is divided into a reset period for initializing all cells, an address period for selecting cells to be discharged, and a sustain period for discharge maintenance of the selected cells.

The reset period is further divided into a setup period and a set-down period. During the setup period, a set-up signal (Ramp-up) with a high voltage is simultaneously supplied to all scan electrodes Y, thereby generating a weak dark discharge within the discharge cells of the whole screen. This results in wall charges being accumulated within the cells.

During the set-down period, a set-down signal (Ramp-down) is simultaneously supplied to the scan electrodes Y, thereby generating a weak erase discharge within the cells. Furthermore, the remaining wall charges are uniform inside the cells to the extent that the address discharge can be stably performed. The set-down signal (Ramp-down) may have a scan voltage (−Vy).

During the address period, a scan pulse (Scan) with the scan voltage (−Vy) is sequentially applied to the scan electrodes Y and, at the same time, a data signal (data) is selectively applied to the data electrodes X. As the voltage difference between the scan signal (Scan) and the data signal (data) is added to the wall voltage generated during the reset period, the address discharge occurs within the discharge cells to which the data pulse (data) is applied. Wall charges are formed inside the cells selected by performing the address discharge.

A positive voltage Vz is supplied to the sustain electrode Z during the set-down period and the address period so that an erroneous discharge does not occur between the sustain electrode Z and the scan electrode.

During the sustain period, a sustain signal (sus) is alternately supplied to the scan electrode Y and the sustain electrode Z such that a sustain discharge occurs.

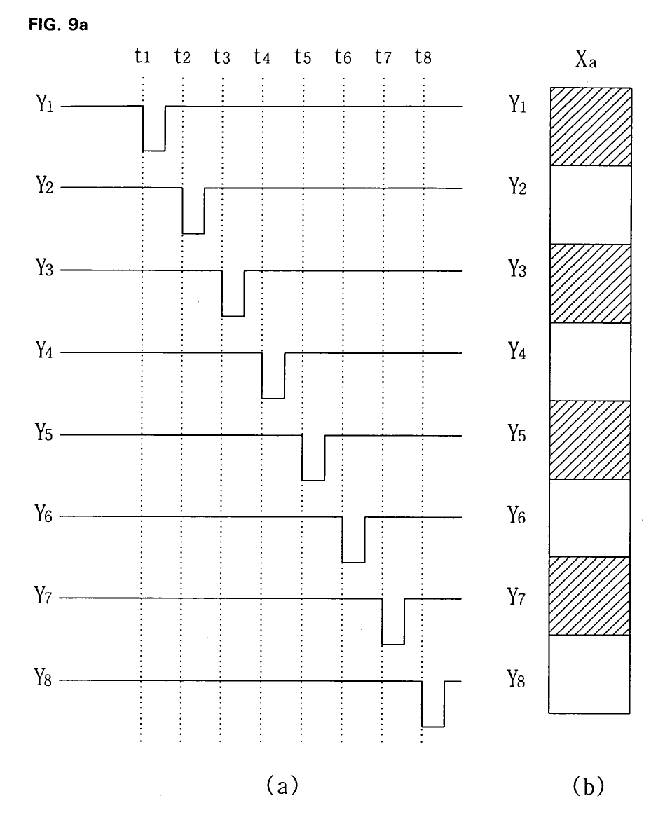

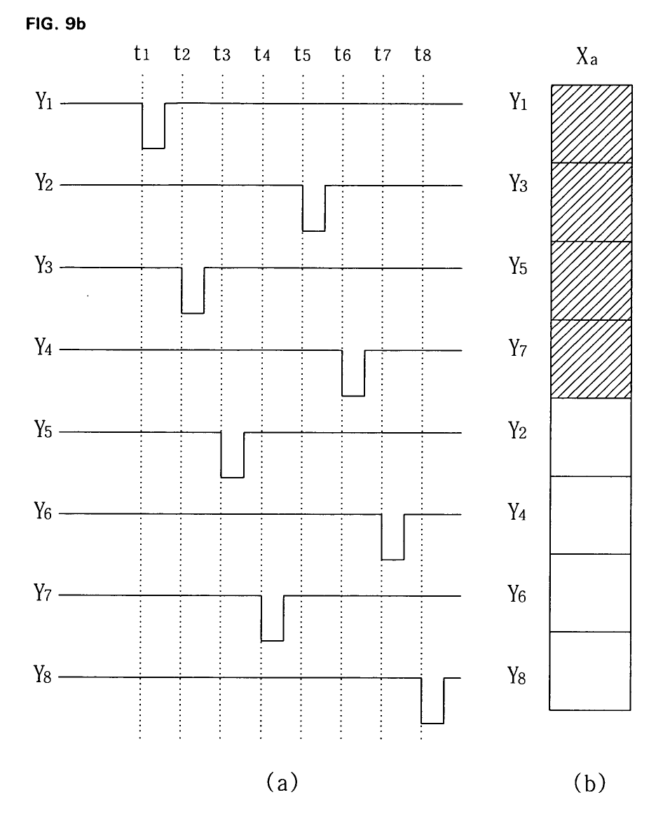

FIGS. 9a and 9b illustrate various scan types, which are different from one another in the order of supplying scan signals to a plurality of scan electrodes.

Referring to FIG. 9a, (a) illustrates a method for sequentially supplying the scan signals to the first scan electrode Y1 to the eighth scan electrode Y8. In this case, as illustrated in (b) of FIG. 9a, data with a repeating pattern of high and low voltage levels may be supplied. For example, a data signal with a high voltage level is supplied to a discharge cell located at an intersection of an Xa data electrode and the second scan electrode Y2, a discharge cell located at an intersection of the Xa data electrode and the fourth scan electrode Y4, a discharge cell located at an intersection of the Xa data electrode and the sixth scan electrode Y6, and a discharge cell located at an intersection of the Xa data electrode and the eighth scan electrode Y8. Further, a data signal with a low voltage level is supplied to discharge cells located at intersections of the Xa data electrode and the remaining first, third, fifth and seventh scan electrodes Y1, Y3, Y5 and Y7.

In this case, the data driver consecutively performs on/off switching operations in order to supply the data signals with the repeating pattern of the high and low voltage levels. Accordingly, the number of switching operations of the data driver increases, thereby increasing the generation of a displacement current. Due to this, the possibility of an electrical damage to the data driver increases. The number of switching operations of the data driver may be equal to the number of changes in a voltage level of a data signal.

Next, referring to FIG. 9b, as compared to the case of FIG. 9a, there is a case where the scan signals are supplied to the first scan electrode Y1 to the eighth scan electrode Y8 using the scanning order different from the scanning order illustrated in FIG. 9a, and the data signal with the same pattern is supplied. For example, it is assumed that the scan signals are supplied to the first, third, fifth, seventh, second, fourth, sixth and eighth scan electrodes Y1, Y3, Y5, Y7, Y2, Y4, Y6, Y8 in the order named. That is, as compared to FIG. 9a, the pattern of data is the same, and the scanning order, i.e., the supply order of scan signals is different.

In this case, the data driver supplies a data signal with a high voltage level during the supplying of the scan signals to the first, third, fifth and seventh scan electrodes Y1, Y3, Y5 and Y7. The data driver supplies a data signal with a low voltage level during the supplying of the scan signals to the second, fourth, sixth and eighth electrodes Y2, Y4, Y6 and Y8.

In other words, when the scan signals are supplied to the first, second, third, fourth, fifth, sixth, seventh and eighth scan electrodes Y1, Y2, Y3, Y4, Y5, Y6, Y7, Y8 in the order named as illustrated in FIG. 9a, the data driver performs a total of seven times of switching operations. On the other hand, when the scan signals are supplied to the first, third, fifth, seventh, second, fourth, sixth, and eighth scan electrodes Y1, Y3, Y5, Y7, Y2, Y4, Y6, Y8 in the order named as illustrated in FIG. 9b, the data driver performs only a total of one time of switching operation. Accordingly, a magnitude of the displacement current generated in the data driver in FIG. 9b is reduced, thereby preventing the electrical damage to the data driver.

Although a scan type has been so far applied in consideration of only the number of changes in a voltage level of a data signal supplied to one data electrode, it is possible to apply a scan type in consideration of the difference in voltage levels of data signals supplied to two or more adjacent data electrodes.

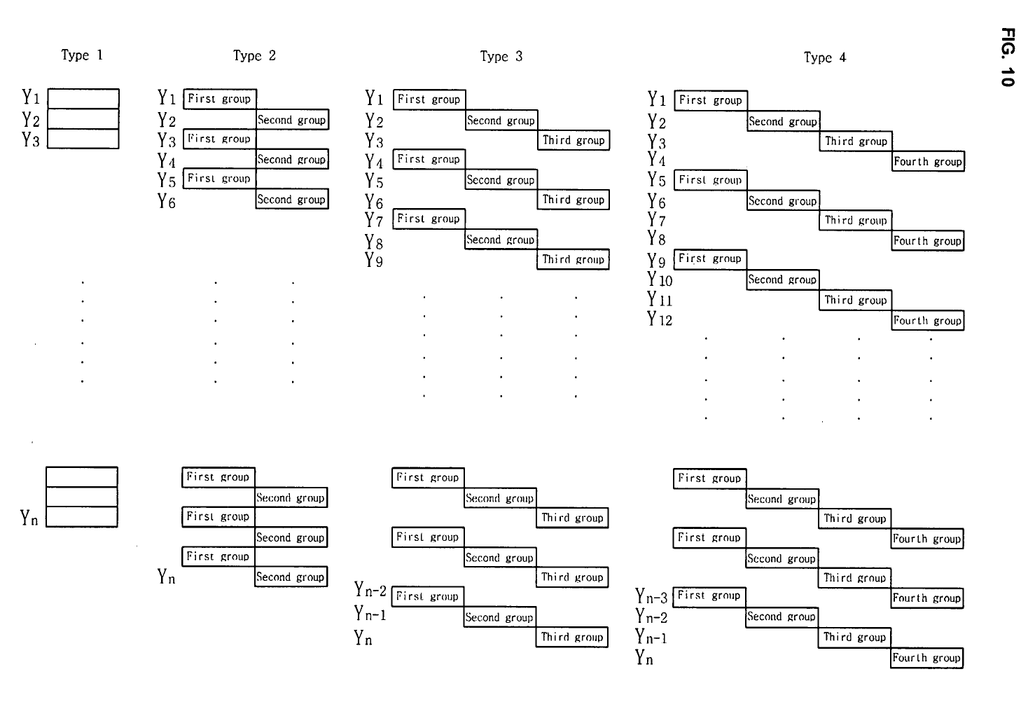

FIG. 10 illustrates a plurality of scan types, which are different from one other in the order of supplying scan signals to the plurality of scan electrodes.

Referring to FIG. 10, during the address, scan signals may be supplied to the plurality of scan electrodes using a plurality of scan types which are different from one another in the order of supplying the scan signals to the plurality of scan electrodes.

For example, scanning may be performed, i.e., scan signals may be supplied to the scan electrodes, using at least one scan type among a total of four scan types, e.g., a first type (Type1), a second type (Type2), a third type (Type3), and a fourth type (Type4).

The first scan type (Type1) is a scan type for supplying scan signals in the order of arrangement of the scan electrodes like the first, second, third, . . . scan electrodes Y1, Y2, Y3, . . . .

The second scan type (Type2) is a scan type for consecutively supplying scan signals to odd-numbered scan electrodes and for consecutively supplying scan signals to even-numbered scan electrodes. For example, the second scan type (Type2) is a scan type for supplying scan signals in the order of the first, third, fifth, . . . , (n−1)-th scan electrodes Y1, Y3, Y5, . . . , (Yn−1), and for supplying scan signals in the order of the second, fourth, sixth, . . . , n-th scan electrodes Y2, Y4, Y6, . . . Yn. The first, third, fifth, . . . , n−1)-th scan electrodes Y1, Y3, Y5, . . . . (Yn−1) are grouped into the scan electrodes of a first group, and the second, fourth, sixth, . . . , n-th scan electrodes Y2, Y4, Y6, . . . . Yn are grouped into the scan electrodes of a second group.

The third scan type (Type3) is a scan type for consecutively supplying scan signals to triple-numbered scan electrodes, i.e., for consecutively supplying scan signals to 3a-th scan electrodes, or for consecutively supplying scan signals to (3a+1)-th scan electrodes, or for consecutively supplying scan signals to (3a+2)-th scan electrodes, wherein a is an integer greater than 0. For example, the third scan type (Type3) is a scan type for supplying scan signals in the order of the first, fourth, seventh, . . . , (n−2)-th scan electrodes Y1, Y4, Y7, . . . , (Yn−2), for supplying scan signals in the order of the second, fifth, eighth, . . . , (n−1)-th scan electrodes Y2, Y5, Y8, . . . . (Yn−1), and for supplying scan signals in the order of the third, sixth, ninth, . . . , n-th scan electrodes Y3, Y6, Y9, . . . , Yn. The first, fourth, seventh, . . . , (n−2)-th scan electrodes Y1, Y4, Y7, . . . .(Yn−2) are grouped into the scan electrodes of a first group, the second, fifth, eighth, . . . .(n-1)-th scan electrodes Y2, Y5, Y8, . . . , (Yn−1) are grouped into the scan electrodes of a second group, and the third, sixth, ninth, . . . , scan electrodes of a third group.

The fourth scan type (Type4) is a scan type for consecutively supplying scan signals to quadruple-numbered scan electrodes, i.e., for consecutively supplying scan signals to 4b-th scan electrodes, or for consecutively supplying scan signals to (4b+1)-th scan electrodes, or for consecutively supplying scan signals to (4b+2)-th scan electrodes, or consecutively supplies scan signals to (4b+3)-th scan electrodes, wherein b is an integer greater than 0. For example, the fourth scan type (Type4) is a scan type for supplying scan signals in the order of the first, fifth, ninth, . . . , (n−3)-th scan electrodes Y1, Y5, Y9, . . . , (Yn−3), for supplying scan signals in the order of the second, sixth, tenth, . . . , (n−2)-th scan electrodes Y2, Y6, Y10, . . . , (Yn−2), for supplying scan signals in the order of the third, seventh, eleventh, . . . , (n−1)-th scan electrodes Y3, Y7, Y11, . . . , Yn−1, and for supplying scan signals in the order of the fourth, eighth, twelfth, . . . , n-th scan electrodes Y4, Y8, Y12, . . . , Yn. The first, fifth, ninth, . . . , (n−3)-th scan electrodes Y1, Y5, Y9, . . . . (Yn−3) are grouped into the scan electrodes of a first group, the second, sixth, tenth, . . . , (n−2)-th scan electrodes Y2, Y6, Y10, . . . , (Yn−2) are grouped into the scan electrodes of a second group, the third, seventh, eleventh, . . . , (n−1)-th scan electrodes Y3, Y7, Y11, . . . , Yn−1 are grouped into the scan electrodes of a third group, and the fourth, eighth, twelfth, . . . , n-th scan electrodes Y4, Y8, Y12, . . . , Yn are grouped into the scan electrodes of a fourth group.

For example, when the number of switching operations of the data driver with respect to the first scan type in the first subfield is less than the number of switching operations of the data driver with respect to the second scan type in the first subfield, the scan signals are supplied to the plurality of scan electrodes using the first scan type (Type1) in the first subfield.

On the contrary, when the number of switching operations of the data driver with respect to the second scan type in the second subfield is less than the number of switching operations of the data driver with respect to the first scan type in the second subfield, the scan signals are supplied to the plurality of scan electrodes using the second scan type (Type2) in the second subfield.

As above, different scan types may be supplied in different subfields.

As explained above, a distance between the scan electrodes belonging to one group to which scan signals are consecutively supplied may be kept substantially equal. For example, in the third type (Type3), among the first, fourth, and seventh scan electrodes Y1, Y4, and Y7 supplied with scan signals in the consecutive order, a distance between the first scan electrode Y1 and the fourth scan electrode Y4 is substantially equal to a distance between the fourth scan electrode Y4 and the seventh scan electrode Y7.

On the contrary, a distance between the scan electrodes belonging to one group to which scan signals are consecutively supplied may be set different from each other. For example, scan signals are consecutively supplied to the first scan electrode Y1, the second scan electrode Y2, and the seventh scan electrode Y7. A distance between the first scan electrode Y1 and the second scan electrode Y2 is different from a distance between the second scan electrode Y2 and the seventh scan electrode Y7.

Although FIG. 10 has illustrated and described a total of four scan types and the method for selecting at least one of the four scan types and supplying scan signals to scan electrodes Y in the order corresponding to the selected scan type, it is possible to provide various numbers of scan types such as two scan types, three scan types, and five scan types, and use the method for selecting at least one of these scan types and supplying scan signals to the scan electrodes Y in an order corresponding to the selected scan type.

As above, when the scan signals are supplied to the scan electrodes using the plurality of scan types, the scan signals are supplied to the scan electrodes using one scan type, in which the number of switching operations of the data driver in response to input image data is the smallest.

Alternatively, scan signals can be supplied to scan electrodes using at least one of the plurality of scan types in which the number of switching operations of the data driver in response to input image data is equal to or less than a threshold value. Here, the magnitude of the threshold value can be determined within a range of sufficiently protecting the data driver from an electrical damage.

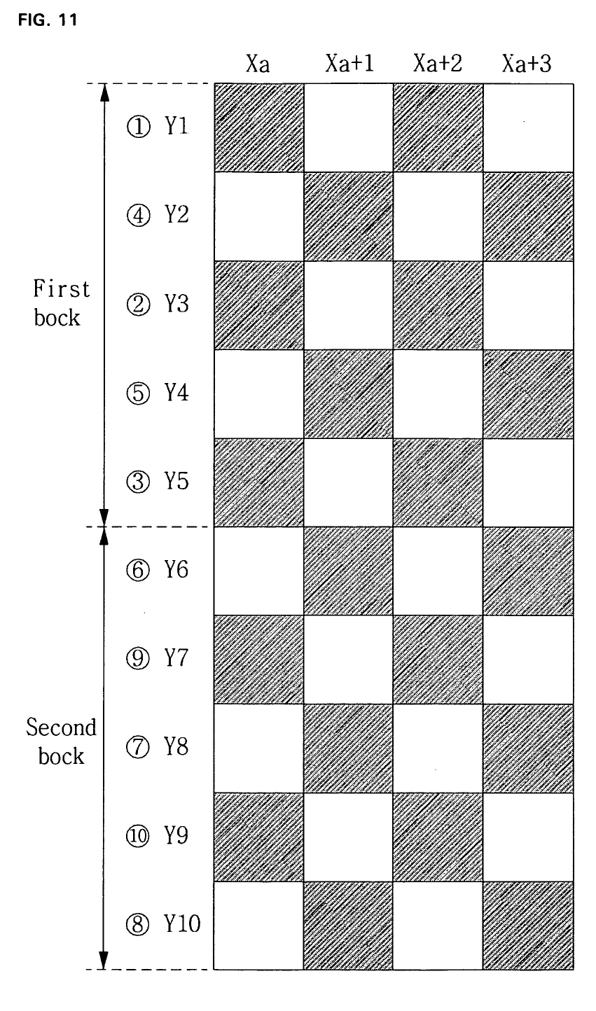

FIG. 11 illustrates one example of a method for determining a scan type by block.

Referring to FIG. 11, in a first block comprising the first scan electrode Y1 to the fifth scan electrode Y5, scan signals are consecutively supplied in the order of the first, third, fifth, second, and fourth scan electrodes Y1, Y3, Y5, Y2, and Y4 as shown in the second type (Type2) of FIG. 10. Further, in a second block comprising the sixth scan electrode Y6 to the tenth scan electrode Y10, scan signals are consecutively supplied in the order of the sixth, eighth, tenth, seventh, and ninth scan electrodes Y6, Y8, Y10, Y7, and Y9 as shown in the second type (Type2) of FIG. 10. Likewise, scan types may be set, respectively, for each block comprising one or more scan electrodes.

Although the number of scan electrodes belonging to each block has been set to be equal in the above, it is possible to set the number of scan electrodes belonging to at least one block different from the number of scan electrodes belonging to other blocks. For example, the first block may comprise 10 scan electrodes, while the second block may comprise 100 scan electrodes.

Further, although the above description has been made with respect to a case where the scan type supplied to each block is the same, the scan type supplied to at least one block may be different from the scan type supplied to other blocks. For example, the third type (Type3) of FIG. 10 may be applied to the first block, and the fourth type (Type4) of FIG. 10 may be applied to the second block.

Moreover, when different scan types are applied to each block, the scan signals are supplied to the scan electrodes using one scan type, in which the number of switching operations of the data driver in response to input image data for each block is the least.

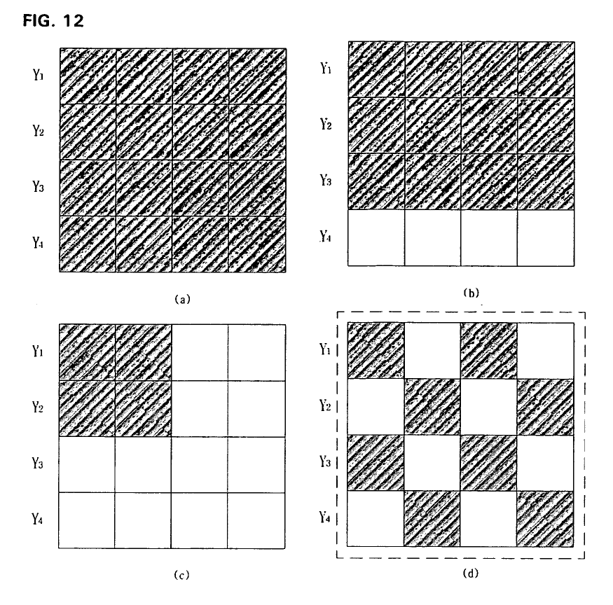

FIG. 12 illustrates another example of a method for determining a scan type relative to a threshold value of the number of switching operations of the data driver.

Referring to FIG. 12, when the number of switching operations of the data driver in response to input image data is equal to or more than a threshold voltage, the scan type may be changed.

For example, (a) illustrates a case where a data signal having a high voltage level is supplied to the discharge cells arranged on all the scan electrodes Y1 to Y4. (b) illustrates a case where a data signal having a high voltage level is supplied to the discharge cells arranged on the first, second, and third scan electrodes Y1, Y2, and Y3, and a data signal having a low voltage level is supplied to the discharge cell arranged on the fourth scan electrode Y4. (c) illustrates a case where a data signal having a high voltage level is supplied to the discharge cells arranged on the first and second scan electrodes Y1 and Y2, and a data signal having a low voltage level is supplied to the discharge cells arranged on the third and fourth scan electrodes Y3 and Y4. (d) illustrates a case where a data signal having a high voltage level is supplied to every other discharge cell.

In the case of (a), the total number of switching operations of the data driver is 0 because there occurs no change in a voltage level of a data signal. In the case of (b), the total number of switching operations of the data driver is equal to 4 because the voltage level of the data signal is changed a total of four times. In the case of (c), the total number of switching operations of the data driver is 2. In the case of (d), the total number of switching operations of the data driver is 12. Assuming that a total of 10 times of switching operations is a threshold value, only the image data of the last (d) pattern among image data of the (a), (b), (c), and (d) patterns may cause the number of switching operations to be greater than the threshold value.

As above, when the number of switching operations is equal to or more than the threshold value, this indicates that an electrical damage may be exerted on the data driver. Therefore, in case of image data of the (a), (b), and (c) patterns, the scan signals are supplied in the order of the first, second, third, and fourth scan electrodes Y1, Y2, Y3, and Y4. In case of image data of the (d) pattern, as shown in the second type (Type2) of FIG. 10, scan signals are supplied in the order of the first, third, second, and fourth scan electrodes Y1, Y3, Y2, and Y4. In this way, it is possible to change the scan type only in the case of image data of a specific pattern.

As above, when the number of switching operations of the data driver in response to input image data with respect to the first scan type (Type1) for sequentially supplying scan signals to the plurality of scan electrodes is equal to or less than the threshold value, the scan signals are supplied to the scan electrodes using the first scan type (Type1). On the other hand, when the number of switching operations of the data driver in response to input image data with respect to the first scan type (Type1) is greater than the threshold value, scan signals are supplied to the scan electrodes using the second scan type (Type2) which is different from the first scan type (Type1).

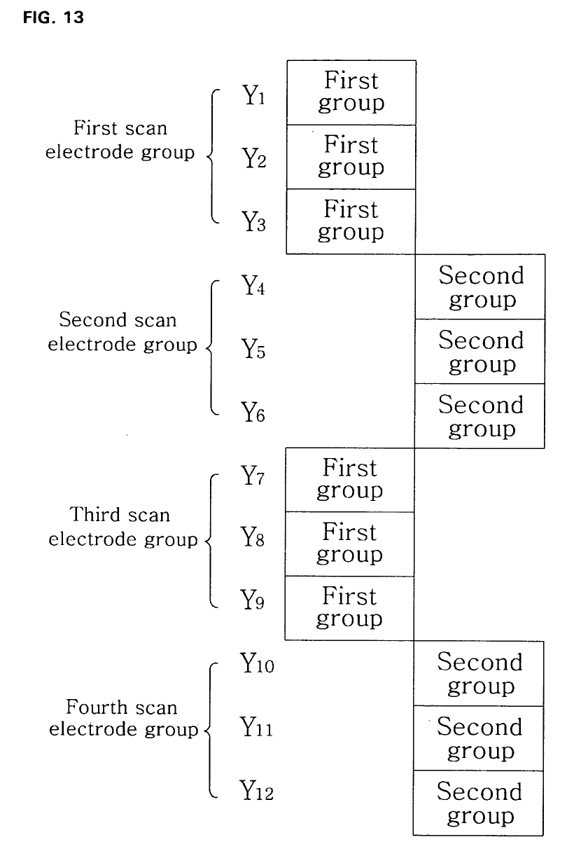

FIG. 13 illustrates another example of a method for supplying scan signals to the plurality of scan electrodes using a plurality of scan types which are different from one other in the order of supplying the scan signals to the scan electrodes.

Referring to FIG. 13, although the above description has been made with respect to a case where scan signals are supplied to the scan electrodes Y using a scan type having a scan order corresponding to each scan electrode Y, it is possible to divide the plurality of scan electrodes into a plurality of scan electrode groups and to supply scan signals to the plurality of scan electrode groups.

For example, the first, second, and third scan electrodes Y1, Y2, and Y3 are set to the first scan electrode group, the fourth, fifth, and sixth scan electrodes Y4, Y5, and Y6 are set to the second scan electrode group, the seventh, eighth, and ninth scan electrodes Y7, Y8, and Y9 are set to the third scan electrode group, and the tenth, eleventh, and twelfth scan electrodes Y10, Y11, and Y12 are set to the fourth scan electrode group. Although in FIG. 13, each scan electrode group is set to comprise three scan electrodes, it is possible to variously change the number of scan electrodes to 2, 4, 5, etc.

Also, it is possible to set at least one of the plurality of scan electrode groups so as to comprise a different number of scan electrodes Y from the other scan electrode groups.

As above, in the case that the scan electrode groups are set, if the second type (Type2) of FIG. 10 is applied, scan signals are consecutively supplied to the scan electrodes belonging to the first scan electrode group, i.e., the first, second, and third scan electrodes Y1, Y2, and Y3, then scan signals are consecutively supplied to the scan electrodes belonging to the third scan electrode group, i.e., the seventh, eighth, and ninth scan electrodes Y7, Y8, and Y9, then scan signals are consecutively supplied to the scan electrodes belonging to the second scan electrode group, i.e, the fourth, fifth, and sixth scan electrodes Y4, Y5, and Y6, and then scan signals are consecutively supplied to the scan electrodes belonging to the fourth scan electrode group, i.e., the tenth, eleventh, and twelfth scan electrodes Y10, Y11, and Y12.

As above, it is possible to apply a scan type for consecutively supplying scan signals to at least one scan electrode belonging to at least one of the plurality of scan electrode groups.

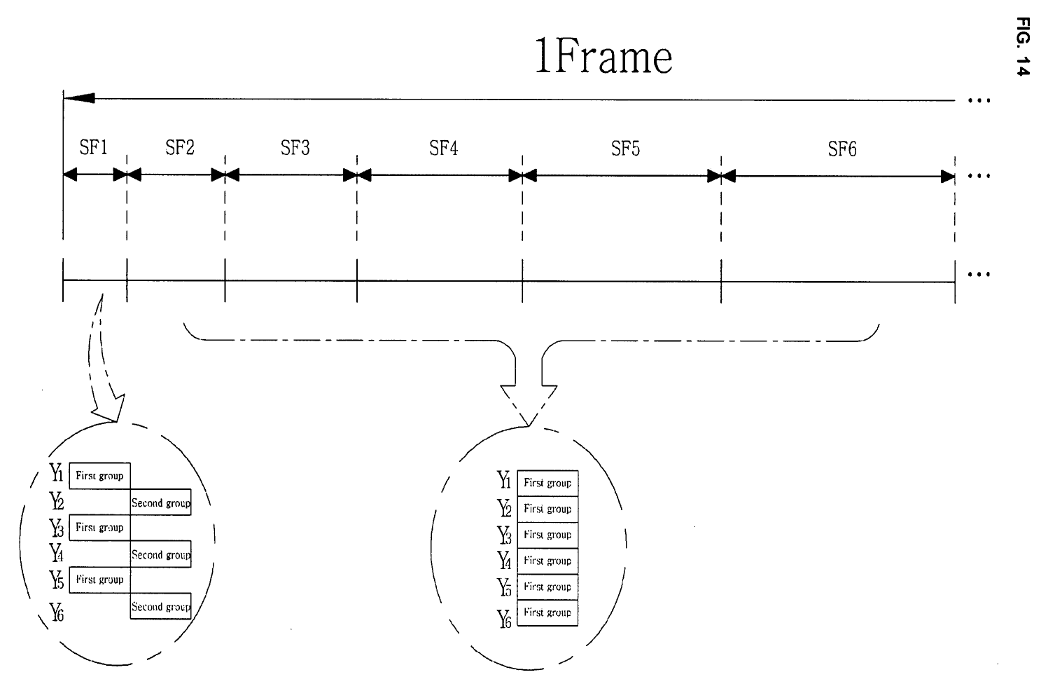

FIG. 14 illustrates one example of a method for determining a scan type in consideration of a subfield.

Referring to FIG. 14, the order of supplying the scan signals to the plurality of scan electrodes in at least one subfield of a frame may be different from the order of supplying the scan signals to the plurality of scan electrodes in other subfields. In other words, it is possible to determine the scan type in consideration of a subfield. For example, the second type (Type2) of FIG. 10 is used in the first subfield SF1 and the first type (Type1) of FIG. 10 is used in the remaining subfields such that the displacement current is minimized.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus, comprising:
a plurality of scan electrodes;
a plurality of sustain electrodes formed in parallel to the plurality of scan electrodes;
a plurality of data electrodes formed to intersect the plurality of scan electrodes and the plurality of sustain electrodes;
a scan driver for supplying scan signals to the plurality of scan electrodes using one scan type selected from a plurality of scan types, each scan type having a different order of supplying the scan signals, during an address period; and
a data driver for supplying a data signal to the plurality of data electrodes in response to the selected scan type,
wherein the width of the data electrode at a first location is different from the width of the data electrode at a second location.

2. The plasma display apparatus of claim 1, wherein the scan driver supplies the scan signals to the plurality of scan electrodes using one scan type selected from the plurality of scan types,
wherein the number of switching operations of the data driver with respect to the selected scan type is less than the number of switching operations of the data driver with respect to each of the non-selected scan types in response to input image data.

3. The plasma display apparatus of claim 2, wherein the number of switching operations of the data driver equals the number of changes in a voltage level of the data signal.

4. The plasma display apparatus of claim 1, wherein at least one of the plurality of scan types comprises a scan type for consecutively supplying the scan signals to the odd-numbered scan electrodes and then to the even-numbered scan electrodes, or for consecutively supplying the scan signals to the even-numbered scan electrodes and then to the odd-numbered scan electrodes.

5. The plasma display apparatus of claim 1, wherein the plurality of scan electrodes comprise a first scan electrode, a second scan electrode, and a third scan electrode, adjacent to one another, to which the scan signals are supplied in a consecutive order, and
a distance between the first scan electrode and the second scan electrode is substantially equal to a distance between the second scan electrode and the third scan electrode.

6. The plasma display apparatus of claim 1, wherein the scan driver supplies the scan signals to the plurality of scan electrodes using one scan type selected from the plurality of scan types,
wherein the number of switching operations of the data driver with respect to the selected scan type is less than the number of switching operations of the data driver with respect to each of the non-selected scan types in response to image data input for each subfield of a frame.

7. The plasma display apparatus of claim 1, wherein at least one of the plurality of scan types comprises a scan type for consecutively supplying the scan signals to the scan electrodes of one scan electrode group.

8. The plasma display apparatus of claim 1, wherein the scan driver supplies the scan signals to the plurality of scan electrodes using at least one of the plurality of scan types, in which the number of switching operations of the data driver in response to input image data is equal to or less than a threshold value.

9. The plasma display apparatus of claim 1, wherein the plurality of scan types comprises a first scan type for consecutively supplying the scan signals to the plurality of scan electrodes, and
the scan driver supplies the scan signals to the scan electrodes using the first scan type when the number of switching operations of the data driver with respect to the first scan type in response to input image data is equal to or less than a threshold value, and the scan driver supplies the scan signals to the scan electrodes using a second scan type, which supplies the scan signals in an order different from the first scan type, when the number of switching operations of the data driver with respect to the first scan type in response to input image data is equal to or more than the threshold value.

10. The plasma display apparatus of claim 1, wherein the first location is a location corresponding to the inside of a discharge cell, and the second location is a location corresponding to a barrier rib.

11. The plasma display apparatus of claim 10, wherein the width of the data electrode at the first location is more than the width of the data electrode at the second location.

12. The plasma display apparatus of claim 11, wherein the width of the data electrode at the first location ranges from 1.05 to 1.6 times the width of the data electrode at the second location.

13. The plasma display apparatus of claim 10, wherein the width of the data electrode at the second location ranges from 1.05 to 2 times the width of a transverse barrier rib.

14. The plasma display apparatus of claim 10, wherein the size of at least one discharge cell of a plurality of discharge cells coated with a plurality of colors is different from the size of the remaining discharge cells.

15. The plasma display apparatus of claim 10, wherein the scan electrode and the sustain electrode each comprise a bus electrode, and the bus electrode is formed at a location corresponding to the inside of the discharge cell.

16. The plasma display apparatus of claim 1, wherein the first location is a location corresponding to the scan electrode, and the second location is a location corresponding to the sustain electrode.

17. The plasma display apparatus of claim 16, wherein the width of the data electrode at the first location is more than the width of the data electrode at the second location.

18. A plasma display apparatus, comprising:
a plurality of scan electrodes each comprising a bus electrode;
a plurality of sustain electrodes, each comprising a bus electrode, formed in parallel to the plurality of scan electrodes;
a plurality of data electrodes formed to intersect the plurality of scan electrodes and the plurality of sustain electrodes;
a scan driver for supplying scan signals to the plurality of scan electrodes using a first scan type in a first subfield of a frame, and for supplying the scan signals to the plurality of scan electrodes using a second scan type, which directs the scan driver to supply the scan signals in an order different from the first scan type, in a second subfield of the frame; and
a data driver for supplying a data signal corresponding to the scan signals to the plurality of data electrodes during an address period,
wherein the width of the data electrode at a location corresponding to the inside of a discharge cell becomes narrower near a boundary of the discharge cell, and is then constant, and the bus electrode is formed at a location corresponding to the inside of the discharge cell.

19. The plasma display apparatus of claim 18, wherein the number of times of switching of the data driver with respect to the first scan type in the first subfield is less than the number of times of switching of the data driver with respect to the second type in the first subfield.

20. The plasma display apparatus of claim 18, the scan driver supplies the scan signals to the plurality of scan electrodes using one scan type of the first scan type and the second scan type, in which the number of switching operations of the data driver in response to input image data is equal to or less than a threshold value.
